(19) United States
(12) Patent Application Publication
(10) Pub. No.: US 2025/0166252 A1
(43) Pub. Date: May 22, 2025

(54) DESIGN STAGE RECOGNITION TO FACILITATE IDEATION

(71) Applicant: Toyota Research Institute, Inc., Los Altos, CA (US)

(72) Inventors: Matthew K. Hong, Mountain View, CA (US); Yin-Ying Chen, San Jose, CA (US); Charlene Wu, San Francisco, CA (US); Matthew Evans Klenk, San Francisco, CA (US); Ian Cartabiano, Torance, CA (US)

(73) Assignees: Toyota Research Institute, Inc., Los Altos, CA (US); Toyota Jidosha Kabushiki Kaisha, Toyota-shi Aichi-ken (JP)

(21) Appl. No.: 19/036,336

(22) Filed: Jan. 24, 2025

Related U.S. Application Data
(63) Continuation-in-part of application No. 18/591,578, filed on Feb. 29, 2024.
(60) Provisional application No. 63/586,632, filed on Sep. 29, 2023.
(60) Provisional application No. 63/556,088, filed on Feb. 21, 2024.

(51) Int. Cl. G06T 11/20; G06T 11/60

(52) U.S. Cl. CPC G06T 11/203; G06T 11/60

(57) ABSTRACT

Systems, methods, and other embodiments described herein relate to improving product ideation through design phase recognition and concept generation. In one embodiment, a method includes acquiring design inputs including at least a text prompt and an active sketch. The method includes, responsive to determining an activity type associated with the active sketch, adapting the design inputs to correspond with the activity type. The method includes generating a guidance image according to the design inputs.

### CROSS-REFERENCE TO RELATED APPLICATIONS

This application is a continuation-in-part of U.S. Non-Provisional application Ser. No. 18/591,578 filed Feb. 29, 2024, which claims the benefit of U.S. Provisional Application No. 63/586,632, filed on Sep. 29, 2023 and U.S. Provisional Application No. 63/556,088, filed on Feb. 21, 2024, which are herein incorporated by reference in their entirety.

### TECHNICAL FIELD

The subject matter described herein relates, in general, to systems and methods for improving ideation and, in particular, to a machine-learning approach that recognizes a design phase and generates concepts having attributes based on the design phase.

### BACKGROUND

The process of product design traditionally involves multiple stages, including ideation, concept development, and iterative refinement. During ideation, designers brainstorm a variety of potential solutions based on defined product requirements and constraints. These ideas are often captured in sketches, which serve as preliminary representations of the designer's vision. However, translating these initial sketches into viable, innovative designs typically requires a significant amount of time and manual effort. Additionally, traditional approaches are often constrained by the individual designer's creativity, expertise, and ability to rapidly evaluate multiple design options.

As the demand for innovative and competitive products grows, there is a need for more efficient and scalable methods to support the ideation and design process. Artificial intelligence (AI) has emerged as a promising tool to assist in various stages of design. A key challenge in automating the ideation process is the efficient interpretation and manipulation of design sketches, which remain one of the most intuitive and widely-used forms of idea representation in the early stages of product development. Various AI-based approaches tend to focus on more structured inputs such as CAD models or digital designs, overlooking the importance of early-stage sketches, which convey a designer's conceptual thoughts in a less formalized manner. Furthermore, many existing systems lack the ability to intelligently refine or evolve an initial sketch into distinct yet feasible design iterations that align with specific design objectives.

### SUMMARY

Example systems and methods relate to improving product ideation through design phase recognition and concept generation. As noted previously, designing a product is a tedious process that involves many iterations over multiple phases. In each phase, the ideation process changes to refine concepts and focus on specific ideas. As such, a user is generally tasked with separately generating sketches having different attributes at each design phase, which may include multiple iterations as design concepts are adapted or restarted. Moreover, identifying separate ideas as inspiration and translating those ideas into actual design concepts can prove to be time-consuming. Therefore, in at least one approach, a system is described that can automatically iterate product designs from an initial sketch input, utilizing AI to explore multiple design alternatives that meet predefined criteria while preserving the designer's original intent. The present approach reduces the time and effort required for product ideation, enhances the variety of design alternatives considered, and ultimately streamlines the path from concept to finished product.

In particular, in at least one arrangement, a disclosed system implements a set of models that at least partially automate the ideation process. For example, the disclosed system involves a multi-part approach in which an initial design input can include a text prompt (e.g., a design inspiration and/or a semantic category), an active sketch, and control parameters. The text prompt may include a description, such as a semantic description along with a descriptive element (e.g., protected vehicle) that can be used by the system as a guide for controlling the ideation. The active sketch is a free-form line drawing that may be a partial or whole representation of a current idea. The control parameters can define a variability of attributes for controlling the subsequent generation of a guidance image for ideation. For example, the control parameters may include visual attributes and text-based attributes. The visual attributes can include a hue, a color contrast, and a level of detail, while the text-based attributes can include a semantic similarity, an analogical similarity, etc.

The system processes the active sketch to identify a type of the sketch, such as an associated phase of the design process (e.g., outline, exploration, finishing, etc.) using an activity model, which is a machine-learning algorithm. Knowing the phase of the design process allows the system to adapt the control parameters to guide image generation so that when the system generates the guidance image, the form of the guidance image fits with a current thought process of the user relative to the design stage. In any case, once the system determines the activity type, then the system converts the active sketch from a sketch-style drawing into a line drawing using a conversion model. That is, a sketch-style drawing is generally composed of free-form lines that may be overlaid and may not define specific boundaries in a definitive manner. However, this type of drawing is not generally well-suited for processing by an image model to generate another image.

Therefore, the system, in at least one approach, refines the active sketch into a line drawing. The line drawing is distinct from the active sketch in that the lines are clearly defined and do not include a multiplicity of free-form lines that are overlaid or roughly adjacent in order to represent a vague approximation of a shape. Thus, once the active sketch is converted into a line drawing and the system adapts the control parameters to alter generating the guidance image according to the activity type, then the system proceeds with generating the guidance image. In at least one arrangement, the system provides the line drawing, the control parameters, and, for example, the text prompt to an image model, which then generates the guidance image. The guidance image is a new image that is intended to inspire ideation on the part of the user. Thus, the system generates the guidance image to include similarities to inputs while introducing distinct suggestions that vary from the inputs according to an extent of variability defined by the control parameters. By way of example, the system may generate the guidance image within a defined range of semantic similarity for the current activity while still adapting features and/or upscaling the image to a high-resolution, adapting colors, and so on.

The system may iteratively provide new forms of the guidance image based on changes to the active sketch and/or the text prompt to facilitate the design process as the design evolves. That is, in at least one arrangement, the system monitors the active sketch for changes (i.e., new drawing strokes) via an interface. When an alteration is detected, the system can then generate a new guidance image and render the new guidance for display in order to provide suggestions to a user, thereby improving the design process. By iteratively and adaptively re-generating the guidance image for the user, the system is able to provide suggestions and facilitate ideation such that the user is provided with multiple suggestions at each design phase in order to improve the design process.

In one embodiment, a design system is disclosed. The design system includes one or more processors and a memory communicably coupled to the one or more processors. The memory stores instructions that when executed by the one or more processors cause the one or more processors to acquire design inputs including at least a text prompt and an active sketch. The instructions include instructions to, responsive to determining an activity type associated with the active sketch, adapt the design inputs to correspond with the activity type. The instructions include instructions to generate a guidance image according to the design inputs.

In one embodiment, a non-transitory computer-readable medium for monitoring health of an electronic device and including instructions that, when executed by one or more processors, cause the one or more processors to perform various functions is disclosed. The instructions include instructions to acquire design inputs including at least a text prompt and an active sketch. The instructions include instructions to, responsive to determining an activity type associated with the active sketch, adapt the design inputs to correspond with the activity type. The instructions include instructions to generate a guidance image according to the design inputs.

In one embodiment, a method is disclosed. The method includes acquiring design inputs including at least a text prompt and an active sketch. The method includes, responsive to determining an activity type associated with the active sketch, adapting the design inputs to correspond with the activity type. The method includes generating a guidance image according to the design inputs.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a design system associated with facilitating ideation by recognizing a design stage and adapting an output according thereto.

FIG. 2 illustrates one embodiment of the system of FIG. 1 integrated within a cloud-based environment.

FIG. 3 illustrates one embodiment of a processing pipeline implemented by the design system of FIG. 1.

FIG. 4 is a schematic illustrating an example process flow.

FIG. 5 is a flowchart illustrating one embodiment of a method for identifying a design stage and generating a guidance image.

FIG. 6 illustrates an active sketch and a corresponding guidance image.

FIG. 7 illustrates multiple iterations of an active sketch and an associated guidance image.

### DETAILED DESCRIPTION

Systems, methods, and other embodiments associated with improving product ideation through design phase recognition and concept generation are disclosed. Designing a product is a tedious process that involves many iterations over multiple phases. In each phase, the ideation process changes to refine concepts and focus on specific ideas. As such, a user is generally tasked with separately generating sketches having different attributes at each design phase, which may include multiple iterations as design concepts are adapted. As may be expected, the process of iterating a design is time-consuming and tedious.

In at least one approach, a system is described that can automatically iterate product designs from an initial sketch input, utilizing a set of machine-learning models to explore multiple design alternatives that meet predefined criteria while preserving the designer's original intent. The present approach reduces the time and effort required for product ideation, enhances the variety of design alternatives considered, and ultimately streamlines the path from concept to finished product.

In at least one arrangement, a design system implements a set of models that at least partially automate the ideation process. For example, the disclosed system involves a multi-part iterative approach in which an initial/current design input can include a text prompt (e.g., a design inspiration and/or a semantic category), an active sketch, and control parameters. The text prompt may include a description, such as a semantic description along with a descriptive element (e.g., protected vehicle) that can be used by the system as a guide for controlling the ideation. For example, the design system can define a semantic similarity of generated ideas in order to constrain suggestions output by the system to those that are within the same idea space as the text prompt. In this way, the text prompt can facilitate control of the ideation process.

The active sketch is a free-form line drawing that may be a partial or whole representation of a current idea. In general, the active sketch may be a current work of the designer that may be provided via a drawing interface such that the active sketch is fed directly into the design system as the design is adapted. This facilitates the iterative nature of the design system and permits detecting changes and successive re-generation of outputs as the design changes. The control parameters can define a variability of attributes for controlling the generation of suggestions (e.g., a guidance image) for ideation. For example, the control parameters may include visual attributes and text-based attributes. The visual attributes can include a hue, a color contrast, a level of detail, etc., while the text-based attributes can include a semantic similarity, an analogical similarity, etc. The control parameters facilitate guiding the ideation according to a design phase such that ideation over subsequent phases focuses more and more on a particular concept and provides further refined ideas.

The system processes the active sketch to identify an activity type associated with the sketch, such as an associated phase of the design process (e.g., outline, exploration, finishing, etc.) using an activity model, which is a machine-learning algorithm. Knowing the phase of the design process allows the system to adapt the control parameters to guide image generation so that when the system generates the guidance image, the form of the guidance image fits with a current thought process of the user relative to the design stage. In any case, once the system determines the activity type, then the system converts the active sketch from a sketch-style drawing into a line drawing using a conversion model. That is, a sketch-style drawing is generally composed of free form lines that may be overlaid and may not define specific boundaries in a definitive manner but instead conveys a general idea of the form of the depicted object. However, this type of drawing is not generally well-suited for processing by an image model to generate another image.

Therefore, the system, in at least one approach, refines the active sketch into a line drawing. The line drawing is distinct from the active sketch in that the lines are clearly defined and do not include a multiplicity of free-form lines that are overlaid nor roughly adjacent in order to represent a vague approximation of a shape. Thus, once the active sketch is converted into a line drawing and the system adapts the control parameters to alter generating the guidance image according to the activity type, then the system proceeds with generating the guidance image. In at least one arrangement, the design system provides the line drawing, the control parameters, and, for example, the text prompt to an image model, which then generates the guidance image. The guidance image is a new image that is intended to inspire ideation on the part of the user. Thus, the system generates the guidance image to include similarities to inputs while introducing distinct suggestions that vary from the inputs according to an extent of variability defined by the control parameters. By way of example, the system may generate the guidance image within a defined range of semantic similarity for the current activity while still adapting features and/or upscaling the image to a high resolution, adapting colors, and so on.

The system may iteratively provide new forms of the guidance image based on changes to the active sketch and/or the text prompt to facilitate the design process as the design evolves. That is, in at least one arrangement, the system monitors the active sketch for changes (i.e., new drawing strokes) via an interface. When an alteration is detected, the system can then generate a new guidance image and render the new guidance according to the current design phase to provide suggestions to a user, thereby improving the design process. By iteratively and adaptively re-generating the guidance image for the user, the system is able to provide suggestions and facilitate ideation such that the user is provided with suggestions at each design phase in order to improve the design process.

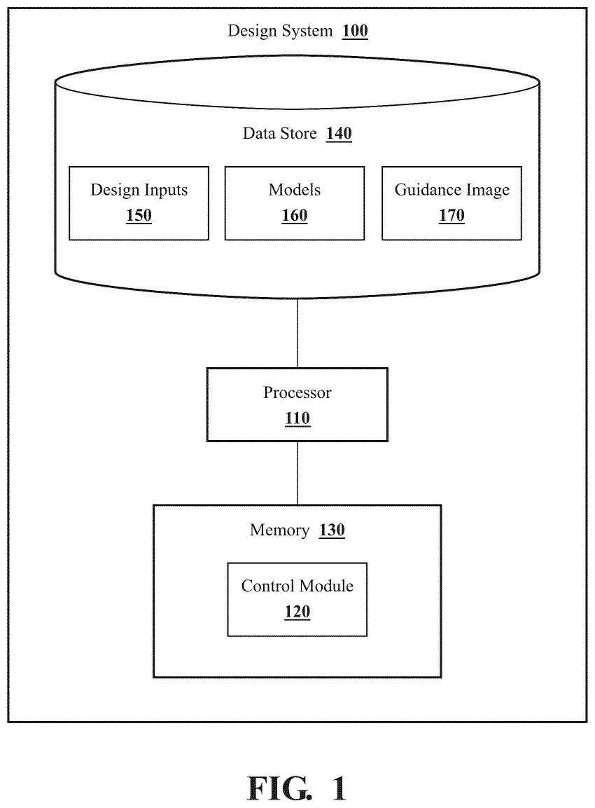

Referring to FIG. 1, one example of a design system 100 that functions to iteratively generate images to support product ideation is shown. While depicted as a standalone component, in one or more embodiments, the design system 100 is cloud-based and thus can include elements that are distributed among different locations. In general, the design system 100 is implemented to facilitate ideation through a process of generating ideas in the form of generative images using various models. The noted functions and methods will become more apparent with a further discussion of the figures.

With further reference to FIG. 1, one embodiment of the design system 100 is further illustrated. The design system 100 is shown as including a processor 110. Accordingly, the processor 110 may be a part of the design system 100, or the design system 100 may access the processor 110 through a data bus or another communication path. In one or more embodiments, the processor 110 is an application-specific integrated circuit (ASIC) that is configured to implement functions associated with a control module 120. In general, the processor 110 is an electronic processor, such as a microprocessor that is capable of performing various functions as described herein. In one embodiment, the design system 100 includes a memory 130 that stores the control module 120 and/or other modules that may function in support of generating depth information. The memory 130 is a random-access memory (RAM), read-only memory (ROM), a hard disk drive, a flash memory, or other suitable memory for storing the control module 120. The control module 120 is, for example, computer-readable instructions that, when executed by the processor 110, cause the processor 110 to perform the various functions disclosed herein. In further arrangements, the control module 120 is a logic, integrated circuit, or another device for performing the noted functions that includes the instructions integrated therein.

Furthermore, in one embodiment, the design system 100 includes a data store 140. The data store 140 is, in one arrangement, an electronic data structure stored in the memory 130 or another electronic medium, and that is configured with routines that can be executed by the processor 110 for analyzing stored data, providing stored data, organizing stored data, and so on. Thus, in one embodiment, the data store 140 stores data used by the control module 120 in executing various functions. For example, as depicted in FIG. 1, the data store 140 includes the design inputs 150, models 160 that are, in at least one approach, machine-learning models, and guidance image(s) 170, along with, for example, other information that is used and/or produced by the control module 120. While the design system 100 is illustrated as including the various elements, it should be appreciated that one or more of the illustrated elements may not be included within the data store 140 in various implementations. In any case, the design system 100 stores various data elements in the data store 140 to support functions of the control module 120.

Continuing with the highlighted data elements, the design inputs 150, in at least one approach, include several components. For example, the design inputs 150 can include an active sketch, a text prompt, control parameters, and so on. The control parameters are used by the design system 100 to control generation of the guidance image 170 by an image model. In particular, the control parameters can relate to the variability of different attributes associated with how the image model performs the image generation. The control parameters are generally comprised of two main elements, visual attributes and text-based attributes. The visual attributes relate to the visual appearance of the guidance image 170 itself and can include a hue, a color contrast, a level of detail and other aspects related to the visual appearance of the image 170. By contrast, the text-based attributes relate to the content or concept/idea of the image 170. Thus, the text-based attributes can include a semantic similarity, an analogical similarity, etc. The semantic similarity is the proximity of the semantic class of the object to the text prompt, e.g., a sedan versus a truck are both types of vehicles but are different classes of vehicles. Accordingly, depending on the variability defined by the semantic similarity, the semantic class of the depicted object may vary outside of the class of the object from the text prompt. Similarly, the analogical similarity refers to a similarity of a superficial appearance of the object. Thus, the analogical similarity relates, in general, to the descriptive form of the text prompt (e.g., protective, sleek, etc.). As such, depending on the variability defined in the control parameters for this term, the design system 100 can vary the variance from the description for the design.

With continued reference to the design inputs 150, the text prompt includes at least a semantic class for the object that is to be generated by the design system 100. The semantic class defines a type of the object, e.g., vehicle, cup, bicycle, etc. The text prompt may describe the object according to a broad semantic class (e.g., vehicle) or a narrower semantic class (e.g., pickup truck). In general, the text prompt can vary across a wide latitude of possible terms to describe the object. Moreover, the text prompt may also include one or more descriptive terms for the object. The descriptive terms describe attributes/characteristics of the object, such as a general character of the object (e.g., slim, robust, protected, etc.). Beyond structural aspects of the aesthetic of the design, the text prompt may also describe colors, textures, patterns, shapes, and so on for the overall design and/or specific aspects of the design.

Lastly, the design inputs 150 can also include an active sketch. The active sketch is a free-form drawing that is typically generated by a user via a drawing interface but may also be provided through other interfaces with the design system 100. The drawing interface may be a stylus-based interface device that generates lines of a drawing according to strokes of the stylus on a display or interface pad. In any case, the active sketch represents a drawing that depicts at least a partial representation of the object being designed. Moreover, the active sketch may vary depending on the activity type of the user. That is, the line thickness and style may vary from a outlining stage to a finishing stage such that the lines for outlining may be light lines that are duplicated in proximity to a general shape of the object and loosely follow a shape of the object while lines for a finishing stage may be thicker and directly represent the intended shape.

Continuing with the elements shown in the data store 140, the models 160 are, in one arrangement, machine-learning models and/or other algorithms. In one arrangement, the models 160 include an activity model, a conversion model, and an image model. Each of the models 160, in at least one approach, serve a different purpose within the design system 100. For example, the activity model functions to analyze the active sketch and determine an activity from the active sketch. The activity type is, in at least one arrangement, a current design phase, such as outlining/sketching, exploration, finishing, etc. The activity model itself is a machine-learning model, such as a convolutional neural network (CNN), a transformer-based network, or another network that can accept an image (i.e., the active sketch) and provide a classification of the activity type as an output.

The conversion model is a machine-learning model and, in particular, is a generative model that intakes the active sketch and generates a line drawing. The line drawing is a refined form of the active sketch in that the conversion model converts the free-form lines of the active sketch into defined lines of the object. For example, where the active sketch may include multiple lines representing an edge of the object, the conversion model is able to reconcile the multiple lines into a defined line for the line drawing. Similarly, conversion model may fill in areas without lines in order to complete the line drawing. In general, the conversion model may be a convolutional-based model, a transformer-based model, a diffusion model, or another machine-learning architecture that processing image data from one form into another.

Lastly, the models 160 include an image model. The image model is the model that generates the guidance image 170. The image model itself is a machine-learning model that performs image generation based on the various inputs. The inputs to the image model include the line drawing from the conversion model, the control parameters, and the text prompt. The image model uses the inputs to generate the guidance image 170. The image model itself is a machine-learning algorithm that is a generative network, such as a transformer-based network, a diffusion model, or another generative approach. In any case, the guidance image 170 is an image of an object that is to function as a source of inspiration for the design process. The image model generates the guidance image 170 within a defined semantic similarity of the text prompt and according to any variables defined by the other control parameters. In this way, the design system 100 is able to facilitate ideation by providing ideas that relate to the sketch and the text prompt.

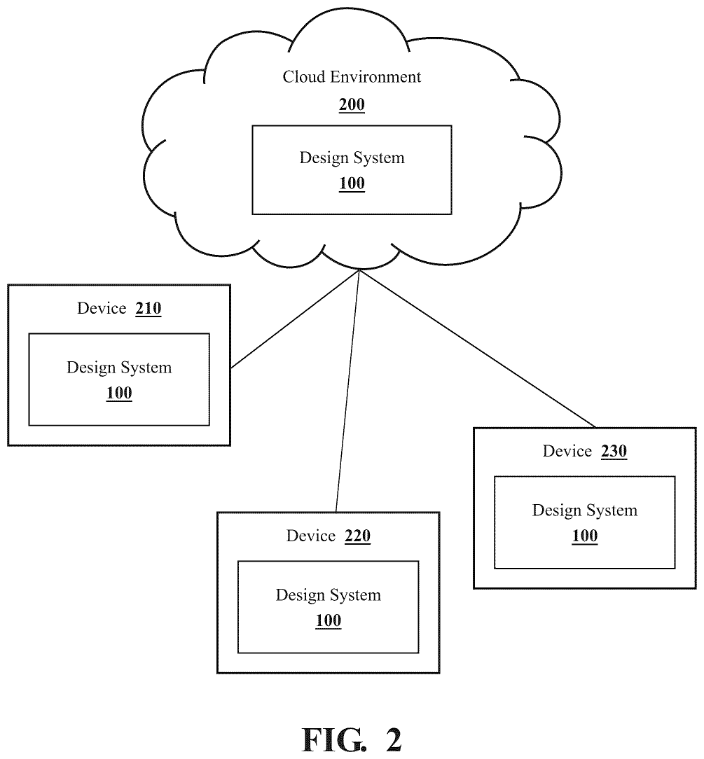

A further embodiment of the design system 100 is illustrated in FIG. 2. As previously noted, the design system 100 may be further implemented within, for example, a cloud-based environment 200, as illustrated in relation to FIG. 2. That is, for example, the design system 100 may acquire data (e.g., design inputs 150) from client instances within the devices 210, 220, and 230 and perform analysis at a remote server that is integrated as part of the cloud environment 200. Accordingly, the instances of the design system 100 within the devices 210, 220, and 230 communicate via wired or wireless connections with the cloud-environment 200. For example, the communications may be via a cellular network (e.g., Frequency-Division Multiple Access (FDMA), Code-Division Multiple Access (CDMA), etc.), a peer-to-peer (P2P) based network, WiFi, DSRC, V2I, V2V or another communication protocol that is capable of conveying the design inputs 150 and determinations according thereto between the entities.

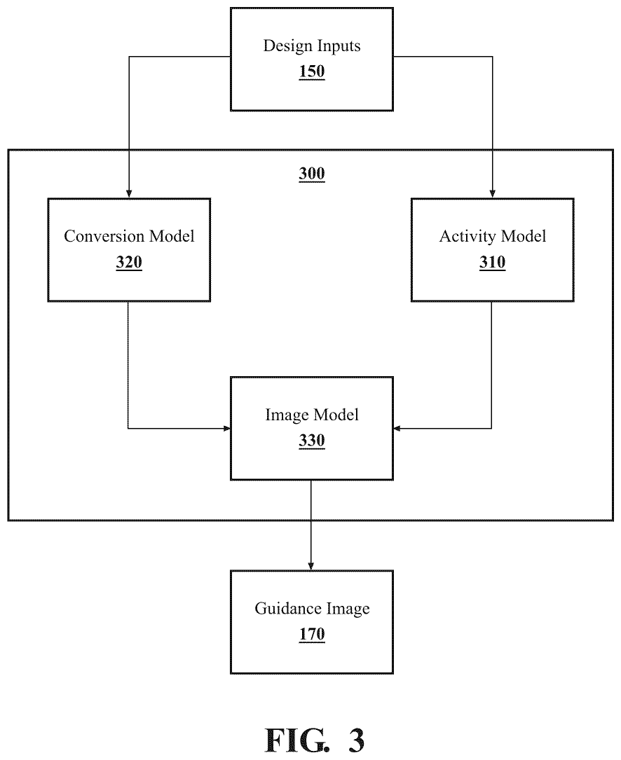

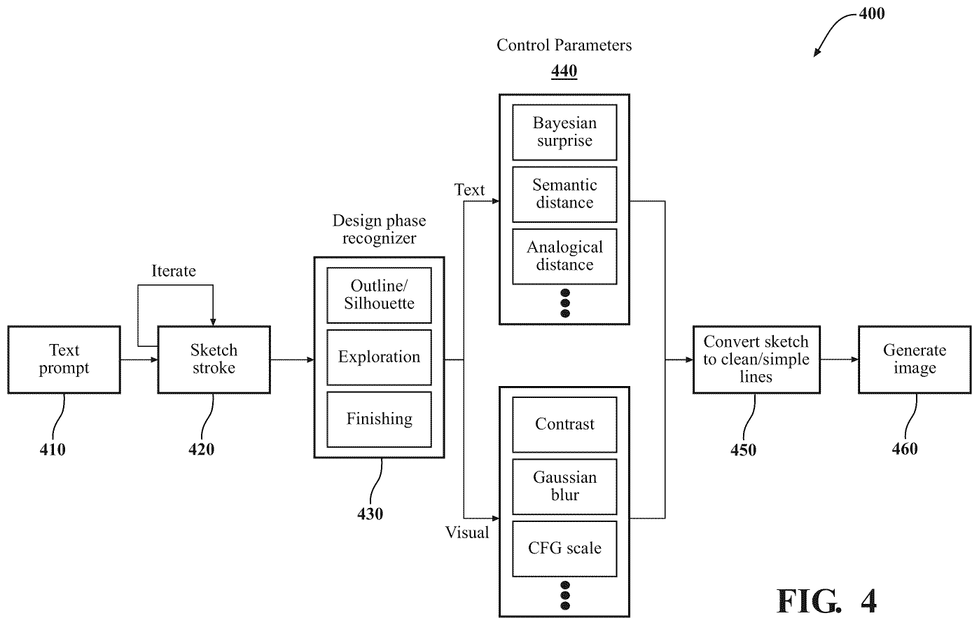

With reference to FIG. 3, one example of a processing pipeline 300, as may be implemented by the control module 120 is shown. Discussion of FIG. 3 will be provided in combination with the discussion of FIG. 4. FIG. 4 illustrates a system flow 400 for the design system 100 that is associated with the processing pipeline 300. As shown in FIG. 3, the control module 120 initially acquires the design inputs 150. This is shown at 410 and 420 in FIG. 4 where the control module 120 acquires the text prompt (e.g., via an interface) and also acquires the active sketch via detection of a sketch stroke at 420. As shown in FIG. 4 at 420, the control module 120 may iteratively acquire the active sketch as the user adapts the active sketch through a drawing interface. For example, as one mechanism for initiating the generation of the guidance image 170, the control module 120 can monitor an interface through which the active sketch is generated to identify when a modification to the active sketch occurs. The modification may be the addition, deletion, or modification of a stroke/line. Accordingly, when the control module 120 detects the change, the control module 120 applies the activity model 310 to the active sketch, as shown at block 430 in FIG. 4.

The activity model 310 functions to recognize the activity type (e.g., the design phase) from the active sketch by considering, for example, a character of the strokes including line width, line style, a number of lines, and so on. Thus, the activity model 310 is able to discern from the active sketch alone whether the user is at an initial outlining stage where the ideation is not yet focused on a particular form of the object, at an intermediate exploratory stage where the active sketch is beginning to focus on a general form of the object, or at a finishing stage where the ideation is focused on a particular form of the object but is still being iterated to determine the final form.

Based on this determination, the control module 120 then adapts the control parameters at 440. That is, the control module 120 may increment/decrement the control parameters to provide for greater or less variability in the guidance image 170 depending on the activity type. As one example, when the activity type is outlining, then the control module 120 may provide for greater diversity in the output by increasing the semantic distance that is permissible compared to finishing where the semantic similarity or distance should be close so as to avoid generating a suggestion that is outside of the focused idea of the finishing process. In any case, the control module 120 can vary multiple different attributes of the guidance image 170 depending on the activity type. In even further configurations, the control module 120 can consider other factors, such as the number of iterations undertaken, the presence of color versus black/white, and so on.

The control module 120 further converts the active sketch into a line drawing with the conversion model 320 as shown at block 450. In general, the process of converting the active sketch into a line drawing functions as a pre-processing step for the image model 330. That is, the image model 330, in at least one arrangement, produces improved results when using a line drawing instead of a sketch since the lines of the sketch can be more difficult for the image model to recognize. Therefore, the control module 120 uses the conversion model 320 to convert the active sketch into a line drawing before generating the guidance image 170.

Thereafter, the control module 120 generates the guidance image 170 using the image model 330 as shown at block 460. The control module 120 uses the text prompt, the converted image (i.e., the line drawing), and the control parameters, as modified by the control module 120, to generate the guidance image 170 using the image model 330. As noted at block 420, the control module 120 iterates this process for detected changes to the active sketch in order to re-generate the guidance image 170. In yet further approaches, the control module 120 may also provide a prior guidance image 170 to the image model 330 as a further input for generating the guidance image 170.

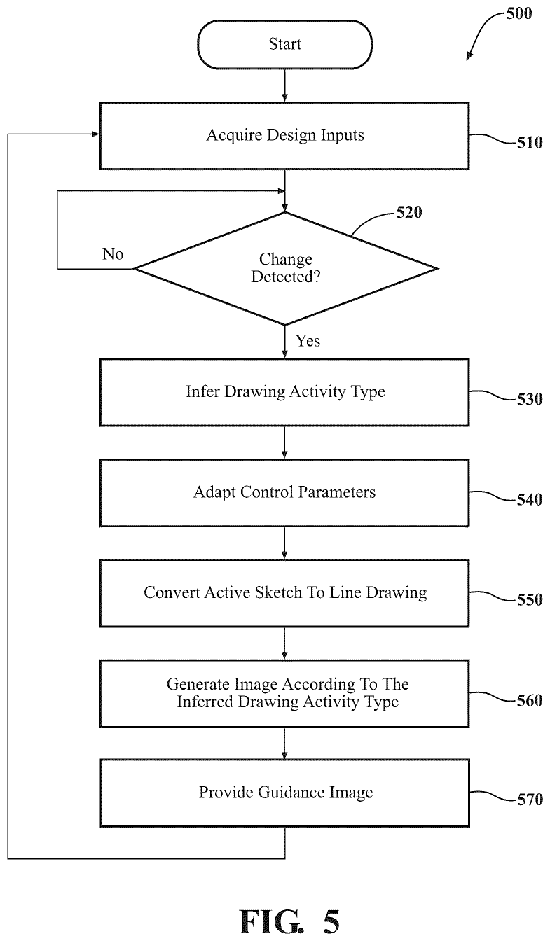

Additional aspects of facilitating ideation by generating guidance images with design suggestions will be discussed in relation to FIG. 5. FIG. 5 illustrates a flowchart of a method 500 that is associated with generating guidance images from sketches. Method 500 will be discussed from the perspective of the design system 100 of FIG. 1. While method 500 is discussed in combination with the design system 100, it should be appreciated that the method 500 is not limited to being implemented within the design system 100 but is instead one example of a system that may implement the method 500.

At 510, the control module 120 acquires at least a portion of the design inputs 150. As indicated previously, the design inputs 150 include control parameters, a text prompt, and an active sketch. The active sketch may be acquired upon detecting a change, as will be described subsequently. However, the control parameters and the text prompt can be acquired at 510 by electronically retrieving the information from various inputs/interfaces. For example, the control module 120 may acquire the control parameters and the text prompt via a user interface. In one arrangement, the user interface may include one or more slider controls that are available to the user so as to allow fine-grained control over the control parameters and, thus, control over variables of the image model. Similarly, the text prompt can be provided as a string of text via the user interface.

At 520, the control module 120 monitors for changes to the active sketch. For example, the control module 120 automates the generation of the guidance image 170 based on sensing when the active sketch changes. In particular, the control module 120 may adapt the guidance image 170 after each pen/brush stroke that modifies the active sketch. While additive strokes are described, the control module 120 may trigger the process according to removal of elements, modification of elements, and/or the addition of elements to the active sketch. The control module 120 may monitor the active sketch itself or the input modality to sense whether a user is actively inputting information to the sketch. In either case, when the control module 120 detects a change, the control module 120 proceeds with subsequent functions.

At 530, the control module 120 infers the activity type associated with drawing the active sketch. The control module 120 uses the activity model to analyze the active sketch according to each stroke provided for adapting the active sketch. The activity model learns to distinguish between different design phases of drawings according to the style of the lines. In particular, the activity model considers, for example, weight, length, speed, density, and other characteristics of the lines of the active sketch. From this analysis, the activity model outputs a determination of the design phase (e.g., outlining, exploration, finishing, etc.).

At 540, the control module 120 adapts the design inputs to correspond with the activity type. The control module 120 automatically and dynamically updates the inputs in response to each stroke and depending on how the stroke was implemented (weight, length, speed, etc.). The control module 120 adaptively changes the multimodal design inputs (e.g., visual and text) to optimize support for the particular design phase. The changes to the control parameters can describe increasing or decreasing meaningful distance in text (e.g., semantic similarity) and visual (e.g., upscaling, color contrast) domains. For instance, in the outline phase, designers could be exposed to generated images with low color contrast or image resolution that increases with each sketch stroke. By contrast, in the exploration phase, the design system 100 exposes the designer to diverse concepts (that are semantically distant from the initial text prompt) incorporated into the generated image. In the finishing phase, the design system 100 may expose designers to concepts that are similar in semantic distance to the text prompt in increased resolution and detail through gradual upscaling as the active sketch acquires more sketch strokes. Moreover, the control module 120 can learn to avoid updating control parameters when the active sketch has repeated strokes over a similar trajectory, whereas the control module 120 can instead gradually increment the hue, perspective height, among other visual variation techniques.

Accordingly, the control module 120 can adapt the control parameters in many different ways depending on the inputs and the current context. Overall, the control module 120 changes the control parameters to alter the generation of the guidance image by the image model. Thus, the particular control parameters and the extent of change can depend on the activity type and current contextual elements of how the active sketch is modified.

At 550, the control module 120 converts the active sketch from a sketch drawing to a line drawing using a conversion model. In general, the conversation model functions to, for example, recognize meaningful lines within the active sketch such that the converted image that is output by the conversion model represents a more specific intent of the designer and removes extraneous strokes. This simplifies the input for the image model and focuses instead on an overall discrete form of the object that is being designed.

At 560, the control module 120 generates the guidance image 170 according to the design inputs. In particular, the control module 120 uses the text prompt, the control parameters, and the converted version of the active sketch as inputs to the image model. The image model is then able to derive a design concept and output the guidance image 170 as a representation of the design concept. In at least one approach, the image model can include an ontological search engine that finds additional images as inspiration and conditions the guidance image 170 according to the design inputs and the additional images. The form of the guidance image 170 itself may vary depending on the implementation and, for example, selection of the control parameters. In at least one arrangement, the guidance image 170 may be a set of images that are different views/angles of the same design concept. In yet further approaches, the guidance image 170 may include multiple separate concepts. In any case, the design system 100 generates the guidance image 170 as a design inspiration to facilitate ideation. Additionally, in various approaches, the design system 100 may further train on labeled sketch data for domain-specific (e.g., face vs product sketches) recognition needs. That is, depending on the text prompt, the image model may tune itself to the particular semantic class. Thus, the design system 100 is adaptable to different contexts in order to provide focused inspiration for the ideation process.

At 570, the control module 120 provides the guidance image 170. In one approach, the control module 120 renders the guidance image 170 on a display, such as the drawing interface that the designer is interfacing with to generate the active sketch. In further approaches, the control module 120 provides the guidance image 170 as a 3D model, as code (e.g., g-code) for a 3D printer to generate a real model, as a schematic design, or in another form to assist in production of the represented design. In this way, the design system 100 facilitate ideation based on the sketched inputs and other defined parameters.

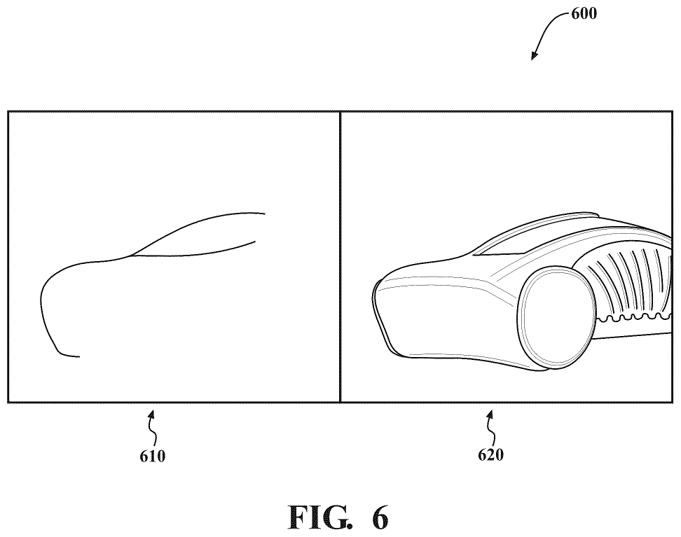

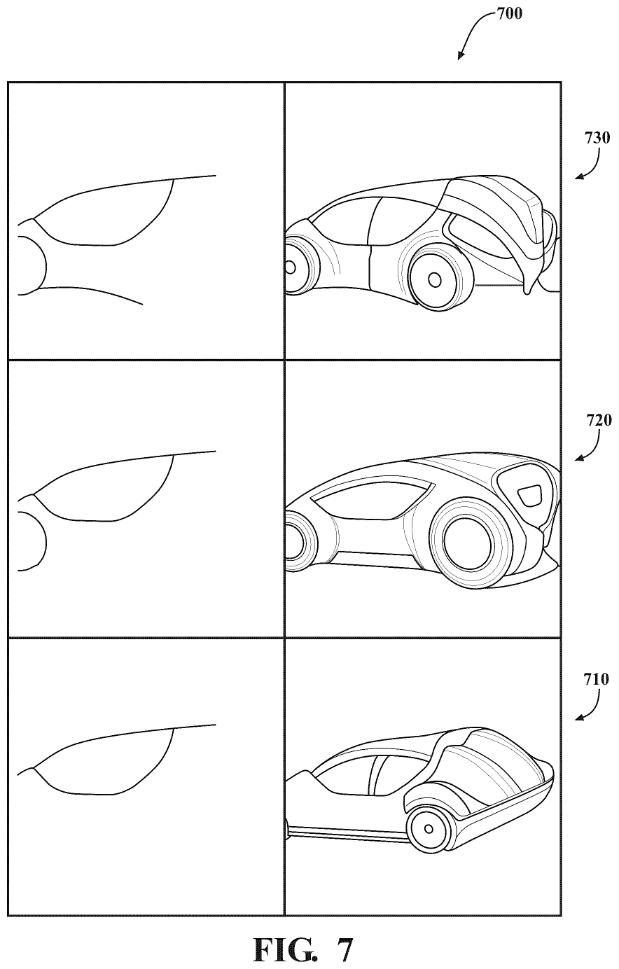

As an example of how the design system 100 uses the active sketch to generate the guidance image 170, consider FIGS. 6-7. FIGS. 6-7 illustrate examples 600 and 700, respectively, of active sketches in comparison to guidance images. As shown in FIG. 6, an active sketch 610 includes only a few lines representing a portion of a vehicle. In this example, the text prompt may include a description, such as protected vehicle. The resulting guidance image for this early-stage sketch (e.g., outlining phase), shows a fully rendered object in the form of a vehicle having “protected” features and a similar shape as that of the active sketch 610.

FIG. 7 shows illustrates a series of guidance images associated with a series of active sketches. In this example, the text prompt is “tortoise shell” vehicle. It can be seen from the progression of the sketches that the design system 100 refines the guidance images more and more according to subsequent inputs. The successive images are not only more detailed and aligned with the active sketch but are also further colored and may have a higher resolution. Accordingly, the design system 100 is able to provide updated suggestions throughout the ideation process to facilitate the designer, thereby improving ideation.

Detailed embodiments are disclosed herein. However, it is to be understood that the disclosed embodiments are intended only as examples. Therefore, specific structural and functional details disclosed herein are not to be interpreted as limiting but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-7, but the embodiments are not limited to the illustrated structure or application.

The flowcharts and block diagrams in the Figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product that comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, module, as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions. The term “operatively connected” and “communicatively coupled,” as used throughout this description, can include direct or indirect connections, including connections without direct physical contact.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a standalone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A design system, comprising:
one or more processors;
a memory communicably coupled to the one or more processors and storing instructions that, when executed by the one or more processors, cause the one or more processors to:
acquire design inputs including at least a text prompt and an active sketch;
responsive to determining an activity type associated with the active sketch, adapt the design inputs to correspond with the activity type; and
generate a guidance image according to the design inputs.

2. The design system of claim 1, wherein the design inputs include the text prompt, the active sketch, and control parameters,
wherein the control parameters define a variability of attributes for controlling an image model to generate the guidance image,
wherein the active sketch is a free-form line drawing provided via a drawing interface, and
wherein the text prompt is semantic description of an object to be depicted in the guidance image.

3. The design system of claim 1, wherein the instructions to adapt the design inputs include instructions to change control parameters to alter generating the guidance image by an image model by correlating the guidance image with the activity type that indicates one of: exploratory, sketching, and finishing.

4. The design system of claim 1, wherein the instructions to generate the guidance image include instructions to convert the active sketch from a sketch drawing to a line drawing using a conversion model and inputting the line drawing into an image model.

5. The design system of claim 1, wherein the instructions to determine the activity type include instructions to analyze the active sketch using an activity model that has learned to distinguish between different design phases of drawings.

6. The design system of claim 1, wherein the instructions to acquire the design inputs include instructions to monitor the active sketch for a change and responsively re-generating the guidance image after adapting the design inputs.

7. The design system of claim 1, wherein the instructions further include instructions to:
provide guidance image by iteratively rendering the guidance image on a display as the active sketch is updated and the guidance image is re-generated.

8. The design system of claim 1, wherein control parameters indicate visual attributes and text-based attributes, the visual attributes including a hue, a color contrast, and a level-of-detail, the text-based attributes including a semantic similarity, and an analogical similarity.

9. A non-transitory computer-readable medium including instructions that, when executed by one or more processors, cause the one or more processors to:
acquire design inputs including at least a text prompt and an active sketch;
responsive to determining an activity type associated with the active sketch, adapt the design inputs to correspond with the activity type; and
generate a guidance image according to the design inputs.

10. The non-transitory computer-readable medium of claim 9, wherein the design inputs include the text prompt, the active sketch, and control parameters,
wherein the control parameters define a variability of attributes for controlling an image model to generate the guidance image,
wherein the active sketch is a free-form line drawing provided via a drawing interface, and
wherein the text prompt is semantic description of an object to be depicted in the guidance image.

11. The non-transitory computer-readable medium of claim 9, wherein the instructions to adapt the design inputs include instructions to change control parameters to alter generating the guidance image by an image model by correlating the guidance image with the activity type that indicates one of: exploratory, sketching, and finishing.

12. The non-transitory computer-readable medium of claim 9, wherein the instructions to generate the guidance image include instructions to convert the active sketch from a sketch drawing to a line drawing using a conversion model and inputting the line drawing into an image model.

13. The non-transitory computer-readable medium of claim 9, wherein the instructions to determine the activity type include instructions to analyze the active sketch using an activity model that has learned to distinguish between different design phases of drawings.

14. A method, comprising:
acquiring design inputs including at least a text prompt and an active sketch;
responsive to determining an activity type associated with the active sketch, adapting the design inputs to correspond with the activity type; and
generating a guidance image according to the design inputs.

15. The method of claim 14, wherein the design inputs include the text prompt, the active sketch, and control parameters,
wherein the control parameters define a variability of attributes for controlling an image model to generate the guidance image,
wherein the active sketch is a free-form line drawing provided via a drawing interface, and
wherein the text prompt is semantic description of an object to be depicted in the guidance image.

16. The method of claim 14, wherein adapting the design inputs includes changing control parameters to alter generating the guidance image by an image model, including correlating the guidance image with the activity type that indicates one of: exploratory, sketching, and finishing, and
wherein the control parameters indicate visual attributes and text-based attributes, the visual attributes including a hue, a color contrast, and a level-of-detail, the text-based attributes including a semantic similarity, and an analogical similarity.

17. The method of claim 14, wherein generating the guidance image includes converting the active sketch from a sketch drawing to a line drawing using a conversion model and inputting the line drawing into an image model.

18. The method of claim 14, wherein determining the activity type includes analyzing the active sketch using an activity model that has learned to distinguish between different design phases of drawings.

19. The method of claim 14, wherein acquiring the design inputs includes monitoring the active sketch for a change and responsively re-generating the guidance image after adapting the design inputs.

20. The method of claim 14, further comprising:
providing guidance image by iteratively rendering the guidance image on a display as the active sketch is updated and the guidance image is re-generated.
